(19) United States
(12) Patent Application Publication
(10) Pub. No.: US 2016/0121942 A1
(43) Pub. Date: May 5, 2016

(54) SPARE TIRE ASSEMBLY FOR A MOTOR VEHICLE

(71) Applicant: FORD GLOBAL TECHNOLOGIES, LLC, Dearborn, MI (US)

(72) Inventors: Francisco Javier Villanueva, Mexico City D.F. (MX); Jose Carlos Parada Centeno, Mexico City D.F. (MX); Omar Arturo Huerta Kanan, Mexico City D.F. (MX)

(21) Appl. No.: 14/526,765

(22) Filed: Oct. 29, 2014

(51) Int. Cl. B62D 43/02

(52) U.S. Cl. CPC B62D 43/02

(57) ABSTRACT

A spare tire assembly for a motor vehicle includes a spare tire mounted on the wheel and a strap system. The strap system has a first end, a second end and an intermediate section. The first end is mounted to the vehicle aft of the spare tire and wheel. The intermediate section extends between the spare tire and a floor of the vehicle and the second end includes a handle.

### TECHNICAL FIELD

This document relates generally to the vehicle equipment field and, more particularly, to a spare tire assembly for a motor vehicle.

### BACKGROUND

Accessing and removing a spare tire from a trunk represents a high challenge for many vehicle operators. In many instances the spare tire is held in a well underneath a false floor of the trunk. Typically the spare tire is very difficult to reach causing the operator to assume an unnatural and even strained position that is not conducive to lifting the spare tire from the well. Here it should be appreciated that the tire and wheel weighs perhaps 25 to 30 pounds and significant strength is required to remove the wheel from the trunk.

This document relates to a spare tire assembly for a motor vehicle incorporating a strap system that utilizes mechanical advantage to aid an operator in removing the spare tire from the trunk including particularly, a well underneath the false floor at the bottom of the trunk.

### SUMMARY

In accordance with the purposes and benefits described herein, a spare tire assembly is provided for a motor vehicle. The spare tire assembly comprises a spare tire, mounted on a wheel, and a strap system. The strap system has a first end, a second end and an intermediate section. The first end is mounted to the vehicle such as to the floor of the vehicle aft of the spare tire. The intermediate section extends between the spare tire and the floor of the vehicle. The second end includes a handle.

In one possible embodiment the intermediate section includes straps forming an x-shape and the first end comprises two strap ends forming spaced anchor points. In addition the strap system includes a cross tie strap connecting the legs of the x-shape. Further the crossing point of the x-shape is positioned between the cross tie strap and the first end.

In one possible embodiment the handle comprises a loop of strap material. In one possible embodiment the assembly further includes a tire retainer that secures the spare tire to the vehicle. The retainer includes a threaded lug that extends through a hub of the wheel and engages the vehicle and a flange that engages and captures the wheel. The retainer may also include a projection on the flange.

In addition the assembly includes a connector for releasably securing the strap system to the tire retainer and holding the handle in a convenient access position above the spare tire. In one possible embodiment the connector is a ring that is received over the projection on the retainer.

In the following description, there are shown and described several preferred embodiments of the spare tire assembly. As it should be realized, the spare tire assembly is capable of other, different embodiments and its several details are capable of modification in various, obvious aspects all without departing from the spare tire assembly as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the spare tire assembly and together with the description serve to explain certain principles thereof. In the drawing:

FIG. 1 is a top plan view illustrating the spare tire assembly provided in a well of the trunk floor.

FIG. 2 is a perspective view illustrating the straps and retainer of the spare tire assembly with the spare tire and wheel removed for clarity of presentation.

FIG. 3 is a detailed view illustrating how one strap at a first end of the strap system is anchored to the floor of the vehicle.

FIG. 4 is a detailed perspective view illustrating how the strap system is releasably connected to the tire retainer to hold the handle of the strap system in a convenient access position above the spare tire.

FIG. 5 is a perspective view illustrating how the spare tire is removed from the well in the trunk floor utilizing the strap system.

FIG. 6 is a view similar to FIG. 5 showing how the strap system may be utilized to pivot the tire upwardly from a prone position onto the tread face without having to lift the entire weight of the spare tire and wheel.

Reference will now be made in detail to the present preferred embodiment of the spare tire assembly, examples of which are illustrated in the accompanying drawing figures.

### DETAILED DESCRIPTION

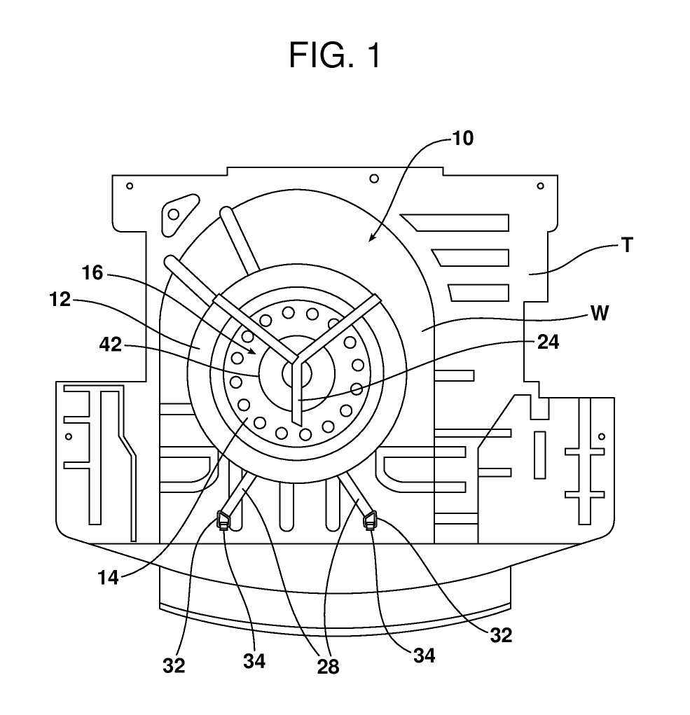

Reference is now made to FIG. 1 illustrating the spare tire assembly 10 resting in a well W provided in the trunk floor T of a vehicle. The spare tire assembly 10 may be generally described as comprising a spare tire 12 mounted on a wheel 14 and a strap system generally designated by reference numeral 16.

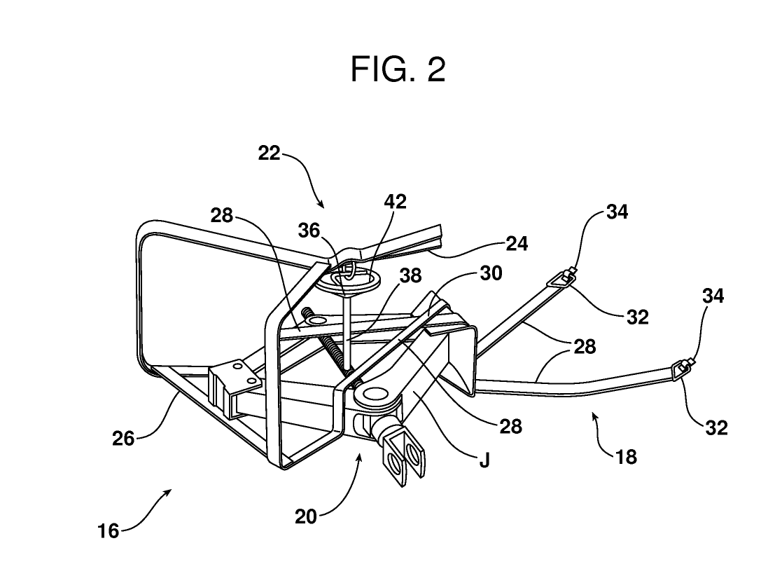

As best illustrated in FIG. 2, the strap system 16 includes a first end 18 that is anchored to the vehicle through the trunk floor T in a manner described below, an intermediate section 20 and a second end 22 that includes or forms a handle 24. The intermediate section 20 includes straps 28 forming an x-shape. A cross tie strap 26 connects the legs 28 of the x-shaped intermediate section 20. Here it should be noted that the crossing point 30 of the x-shaped intermediate section 20 is positioned between the cross tie strap 26 and the first end 18. As illustrated, the strap system 16 extends over the scissor jack J held in place at the bottom of the well W. Thus, the straps extend between the jack J and the spare tire 12 that is not shown in FIG. 2.

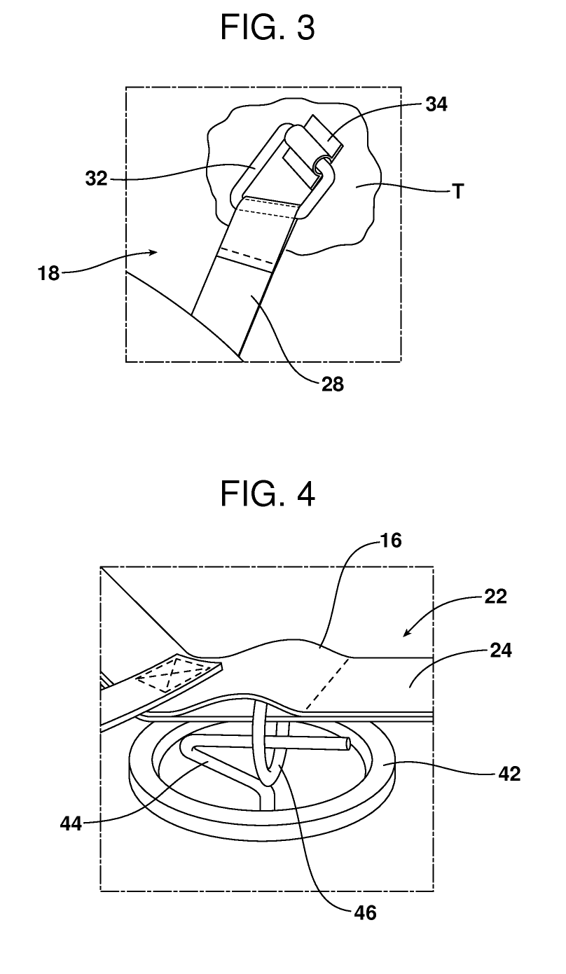

Reference is now made to FIG. 3 illustrating in detail the connection of the first end 18 to the vehicle through the trunk floor T. More specifically, the first end 18 of the strap system 16 comprises the distal ends of the two legs 28 which are each secured to a metal mounting rings 32 (note only one leg is illustrated in FIG. 3). As illustrated, each of mounting rings 32 is connected to the trunk floor T aft of the spare tire 12 by means of the bracket 34 which is welded or otherwise secured to the trunk floor at two spaced anchor points.

Reference is now made to FIGS. 1, 2 and 4 which illustrate a tire retainer 36 that secures the spare tire and wheel assembly 12, 14 to the trunk floor T of the vehicle. As illustrated, the tire retainer 36 includes a threaded lug 38 that extends through a hub 40 of the wheel and engages in a cooperating threaded aperture (not shown) provided in the trunk floor T. In addition, the tire retainer 36 includes a flange 42 that is sized and shaped to engage the hub 40 of the wheel 14 but not pass through the hub so that the wheel and the spare tire 12 mounted thereon are effectively captured between the flange and the trunk floor T so as to be securely held in position within the well W of the vehicle.

As best illustrated in FIG. 4, a lug or projection 44 extends upwardly from the flange 42. A connector, in the form of a ring 46 is secured to the strap system 16 adjacent the second end 22. The ring 46 is positioned around the projection 44 so that the handle 24 is held in a convenient access position above the spare tire 12 where it may be easily accessed to remove the spare tire and wheel 12, 14 from the well W of the trunk floor T.

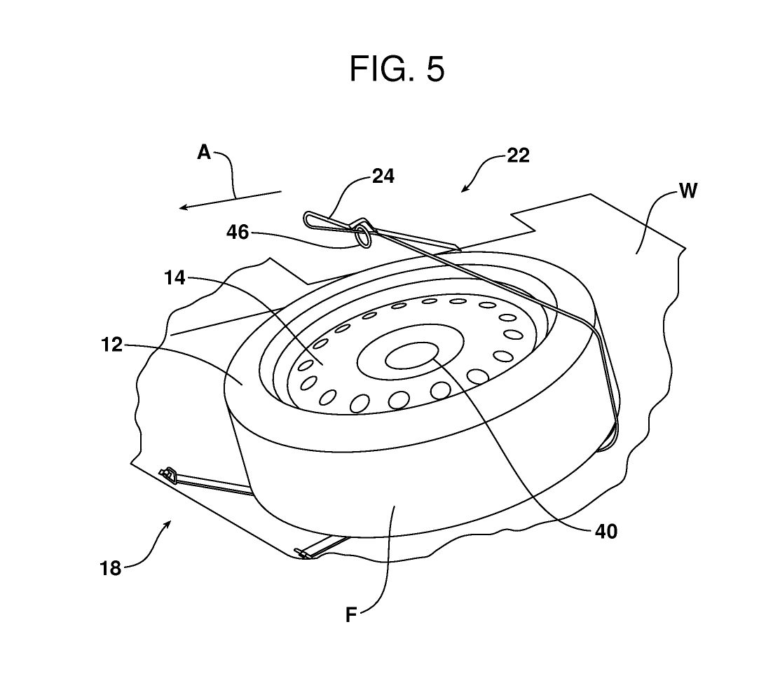

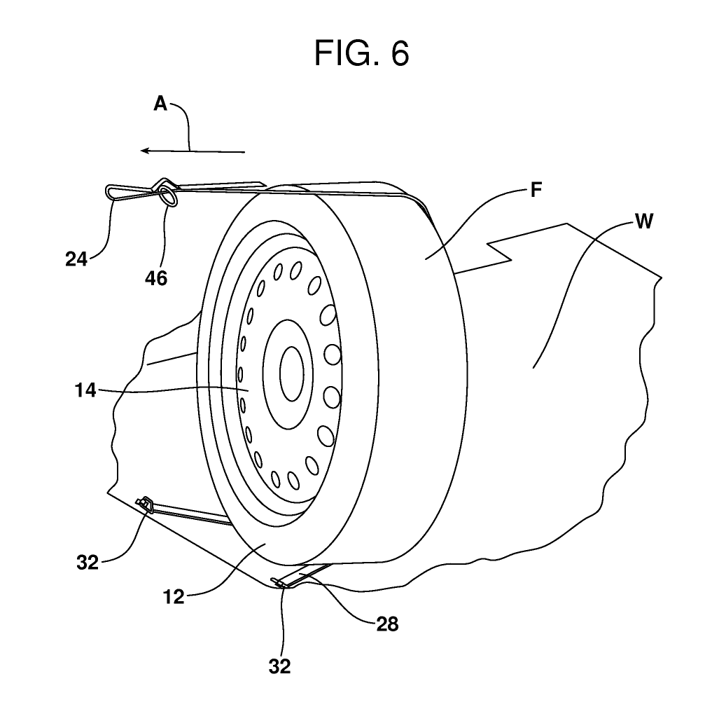

Reference is now made to FIGS. 5 and 6 which illustrate the process of removing the spare tire 12 and wheel 14 for use. In order to access the spare tire and wheel assembly 12, 14 held in the well W of a trunk floor T, one must first remove the overlying false floor or trunk mat (not shown) so as to expose the spare tire and wheel assembly. Next, the individual frees the ring 46 from the projection 44 on the flange 42 of the tire retainer 36 by slipping the ring off the end of the projection.

The individual then utilizes the projection 44 to turn the tire retainer 36 in a counterclockwise direction so as to unscrew the threaded lug 38 of the tire retainer from the cooperating threaded aperture provided in the trunk floor T.

After removal of the tire retainer 36, the individual grasps the handle 24 of the strap system 16 and pulls the strap to him: that is toward the first end 18 of the strap system 16 and the rear of the vehicle (note action arrow A). This causes the spare tire and wheel 12, 14 to tip toward the rear of the vehicle and finally up on to the tread face of the spare tire 12. Note FIG. 5 illustrating the spare tire and wheel 14 as it begins to tip and FIG. 6 illustrating the spare tire and wheel after the spare tire has been fully tipped onto the tread face F.

Once the spare tire and wheel assembly 12, 14 are in the upright position illustrated in FIG. 6 it is much easier for an individual to remove the spare tire from the trunk of the vehicle.

In summary, numerous benefits are provided by the spare tire assembly 10. Significantly, the strap system 16 that is utilized to aid in removing the spare tire and wheel assembly 12, 14 from the trunk well W are relatively inexpensive to produce and may be easily installed in substantially any vehicle to assist in the removal of the spare tire from difficult to reach locations such as the trunk well W. Use of the strap system 16 is intuitive. Advantageously, the strap system 16 is light weight and utilizes mechanical advantage so that the spare tire and wheel assembly 12, 14 are turned from the prone position illustrated in FIG. 1 to the fully upright position on the tread F as illustrated in FIG. 6 without having to actually lift the entire weight of the spare tire and wheel. This is possible because the strap system 16 is anchored at the first end 18 aft of the spare tire and wheel 12, 14 and the intermediate section 20 extends under the first or lower side of the spare tire and wheel, around the tread face F and across at least a portion of the second or top side of the spare tire and wheel to the hub 40. In this position, the handle 24 is easily accessed to tip the spare tire up into the upright position illustrated in FIG. 6 for easier removal from the trunk.

The foregoing has been presented for purposes of illustration and description. It is not intended to be exhaustive or to limit the embodiments to the precise form disclosed. Obvious modifications and variations are possible in light of the above teachings. For example, while the handle 24 in the illustrated embodiment is formed by a loop of strap material, a handle formed from plastic or other material could be secured to the strap if desired. All such modifications and variations are within the scope of the appended claims when interpreted in accordance with the breadth to which they are fairly, legally and equitably entitled.

What is claimed:

1. A spare tire assembly for a motor vehicle, comprising:
a spare tire mounted on a wheel; and
a strap system having a first end, a second end and an intermediate section wherein said first end is mounted to said vehicle, said intermediate section extends between said spare tire and a floor of said vehicle and said second end includes a handle.

2. The assembly claim 1, wherein said first end is mounted to said vehicle aft of said spare tire.

3. The assembly claim 2, wherein said intermediate section includes straps forming an x-shape and said first end comprises two, spaced anchor points.

4. The assembly claim 3, wherein said strap system further includes a cross tie strap connecting legs of said x-shape.

5. The assembly claim 4, wherein a crossing point of said x-shape is positioned between said cross tie strap and said first end.

6. The assembly claim 5, wherein said handle comprises a loop of strap material.

7. The assembly claim 6, further including a tire retainer that secures said spare tire to said vehicle.

8. The assembly claim 7, further including a connector for releasably securing said strap system to said tire retainer and holding said handle in a convenient access position above said spare tire.

9. The assembly claim 8, wherein said tire retainer includes (a) a threaded lug that extends through a hub of said wheel and engages said vehicle and (b) a flange that engages and captures said wheel.

10. The assembly claim 9, wherein said retainer includes a projection on said flange and said connector is a ring received over said projection.

11. The assembly claim 10, wherein said floor includes a well that receives said spare tire and said wheel.

12. A spare tire assembly for a motor vehicle, comprising:
a spare tire mounted on a wheel, said spare tire having a first side, a second side and a tread face and said wheel including a hub; and
a strap system having a first end secured to said vehicle and a second end including a handle, said strap system extending under said first side, around said tread face and across at least a portion of said second side to said hub.

13. The assembly claim 12, further including a tire retainer extending through said hub and engaging said vehicle.

14. The assembly claim 13, further including a connector releasably securing said strap to said tire retainer and holding said handle in a convenient access position above said spare tire.

15. The assembly claim 14, wherein said first end is secured to said vehicle aft of said spare tire.
